(19) United States
(12) Patent Application Publication
(10) Pub. No.: US 2024/0301574 A1
(43) Pub. Date: Sep. 12, 2024

(54) HETEROSTRUCTURED PHOTOELECTROCATALYST AND METHOD OF FABRICATING THE SAME

(71) Applicant: National Tsing Hua University, Hsinchu (TW)

(72) Inventors: Tajen YEN, Zhubei City (TW); Chun-Yen CHEN, Taoyuan City (TW); Ching Han MAO, Hsinchu City (TW)

(21) Appl. No.: 18/362,352

(22) Filed: Jul. 31, 2023

(30) Foreign Application Priority Data
Mar. 10, 2023 (TW) 112108870

(51) Int. Cl. C25B 11/093

(52) U.S. Cl. CPC C25B 11/093

(57) ABSTRACT

A heterostructured photoelectrocatalyst and a method of fabricating the same. The heterostructured photoelectrocatalyst according to the invention includes a substrate, a plurality of nanowires, a plurality of metal nanoparticles and a transition metal compound film. The substrate is formed of a semiconductor material with a first conductive type. The plurality of nanowires are formed of the semiconductor material and formed on an upper surface of the substrate. Each nanowire thereon exists a few of the plurality of metal nanoparticles. The transition metal compound film is formed to overlay the plurality of nanowires and the plurality of metal nanoparticles. The transition metal compound film can formed of a transition metal sulfide, a transition metal telluride or a transition metal selenide. The compound film has a second conductive type different from the first conductive type.

### CROSS-REFERENCE TO RELATED APPLICATION

This utility application claims priority to Taiwan Application Serial Number 112108870, filed Mar. 10, 2023, which is incorporated herein by reference.

### BACKGROUND OF THE INVENTION

### 1. Field of the invention

The invention relates to a heterostructured photoelectrocatalyst and a method of fabricating the same, and more in particular, to a heterostructured photoelectrocatalyst being based on transition metal sulfide or other similar transition metal compounds and having surface plasmon resonance and p-n junction, and a method of fabricating the same.

### 2. Description of the prior art

With the increasingly serious problems of energy crisis, environmental damage, air pollution and global warming, renewable clean energy has received more and more attention. Since hydrogen has the highest energy density (142 MJ/kg) among chemical fuels, it will not pollute the environment after use. Therefore, hydrogen is considered as the most potential energy carrier. Current industrial hydrogen production is by a decomposition method to use petroleum or other hydrocarbons to be produced by steam reformation. This method not only consumes fossil fuels, but also causes the emission of greenhouse gases and pollutants.

Compared with the decomposition method using fossil fuels as raw materials, hydrogen evolution methods such as hydroelectric hydrogen evolution, photocatalytic hydrogen evolution, and electrocatalytic hydrogen evolution are clean hydrogen production methods. So far, there are still many research efforts to improve the efficiency of these hydrogen evolution methods. Among these hydrogen evolution methods, electrocatalytic hydrogen evolution is a hydrogen production method with high efficiency and low energy consumption. However, currently the most efficient electrocatalytic hydrogen evolution reaction is based on noble metal platinum catalysis. The electrocatalytic hydrogen evolution method using platinum is limited by the scarcity and high price of noble metals, which hinders its wide-scale practical application. Therefore, it is increasingly urgent to develop new catalysts with high catalytic performance and low cost.

Another prior art uses TiO₂, a semiconductor material, as a catalyst for the hydrogen evolution reaction. When using TiO₂, it must be considered that TiO₂ exists in three crystalline forms: brookite, anatase (energy gap: 3.23 eV) and rutile (energy gap: 3.02 eV). Only TiO₂ with two crystal forms of anatase and rutile can undergo hydrogen evolution reaction. However, when TiO₂ in different crystal forms is mixed in proportion, different hydrogen evolution effects will appear. Moreover, the oxidation number problem must be considered in the TiO₂ process, which is prone to oxygen vacancies or self-doping defects, which reduces the hydrogen evolution effect.

In addition, most of the prior arts use catalysts in the form of nanoparticles, which are dispersed in an aqueous solution to achieve a catalytic effect. The electron transfer efficiency of catalysts using nanoparticles is rather low. Moreover, the catalyst in the form of nanoparticles has no fixed shape or structure, and its properties are very unstable. In addition, the pH value of the aqueous solution or the concentration of the electrolyte must be considered when using a catalyst in the form of nanoparticles.

The key to hydrogen production by photoelectron-chemical reaction lies in the energy gap size and energy level position of the photoelectric semiconductor catalyst material. The energy gap of the semiconductor must be at least 1.23 eV greater than the redox potential difference of water for the hydrogen evolution reaction to occur. If the transition metal sulfide is an ultra-thin film, its energy gap will change from an indirect energy gap to a direct energy gap. At this time, the potential and energy gap size are very suitable for the hydrogen evolution by water decomposition reaction, and therefore, this material has attracted much attention. However, the photocatalytic effect of simply using transition metal sulfides is not as expected. These reasons are: (1) the electron transfer efficiency of transition metal sulfides is poor, and the electron-hole pairs have been recombined before the water decomposition reaction, and the ratio of electron-hole pairs that can be used is limited and the electron-hole pairs are wasted a lot; (2) when the transition metal sulfide is a two-dimensional material, the light that can be absorbed by the wo-dimensional transition metal sulfide is very limited, and this low absorption and low conductivity have led to the delay in popularization of the photocatalytic hydrolysis technology using transition metal sulfide. In addition, transition metal tellurides and transition metal selenides also have the potential to be developed into high-efficiency catalysts.

With the description of the above prior arts, no high-efficiency catalysts based on transition metal sulfides or other similar transition metal compounds with special structures have been successfully developed so far.

### SUMMARY OF THE INVENTION

Accordingly, one scope of the invention is to provide a heterostructured photoelectrocatalyst and a method of fabricating the same. The heterostructured photoelectrocatalyst according to the present invention are based on transition metal sulfides or other similar transition metal compounds and have surface plasmon resonance effects and p-n junctions. The heterostructured photoelectrocatalyst according to the invention has high catalytic efficiency, and has wide applications in addition to hydrogen evolution reaction, for example, for photocatalytic degradation, air purification (e.g., decomposition of formaldehyde), reduction of CO₂, etc.

A heterostructured photoelectrocatalyst according to a preferred embodiment of the invention includes a substrate, a plurality of nanowires, a plurality of metal nanoparticles and a transition metal compound film. The substrate is formed of a semiconductor material. The substrate has an upper surface. The semiconductor material has a first conductive type. The plurality of nanowires are formed of the semiconductor material, and are formed on the upper surface of the substrate. The plurality of metal nanoparticles are formed on the plurality of nanowires. Each nanowire thereon exists a few of the plurality of metal nanoparticles. The transition metal compound film is formed to overlap the plurality of nanowires and the plurality of metal nanoparticles. The transition metal compound film can be formed of a transition metal sulfide, a transition metal telluride or a transition metal selenide. The transition metal compound film has a second conductive type different from the first conductive type.

In one embodiment, the plurality of metal nanoparticles can be formed of silver (Ag), gold (Au), aluminum (Al), copper (Cu), tin (Sn), titanium (Ti), barium (Ba), platinum (Pt), cobalt (Co) or a mixture therebetween.

In one embodiment, the first conductive type is a p-type, and the second conductive is an n-type. The transition metal compound film can be formed of MoS₂, ZnS, CdS, PdS, MoTe₂, WS₂, GeS, GeSe, HfS₃, TiS₃, or Bi₂Te₃.

In another embodiment, the first conductive type is an n-type, and the second conductive is a p-type. The transition metal compound film can be formed of CuS, SnS, Ag₂S or WSe₂.

In one embodiment, a height of each nanowire ranges from 0.5μ m to 15μ m.

In one embodiment, a diameter of each nanowire ranges from 10 nm to 100 nm.

In one embodiment, a particle size of each metal nanoparticle ranges from 5 nm to 50 nm.

A method of fabricating a heterostructured photoelectrocatalyst according to a preferred embodiment of the invention is, firstly, to prepare a substrate. The substrate is formed of a semiconductor material, and has a first conductive type. Then, the method according to the preferred embodiment of the invention is to partially etch the upper surface of the substrate downwards to form a plurality of nanowires. Next, the method according to the preferred embodiment of the invention is to deposit a plurality of metal nanoparticles on the plurality of nanowires. Each nanowire thereon exists a few of the plurality of metal nanoparticles. Finally, the method according to the preferred embodiment of the invention is to form a transition metal compound film to overlap the plurality of nanowires and the plurality of metal nanoparticles. The transition metal compound film can be formed of a transition metal sulfide, a transition metal telluride or a transition metal selenide. The transition metal compound film has a second conductive type different from the first conductive type.

In one embodiment, the plurality of nanowires can be formed by a metal-assisted chemical etching process or a reactive ion etching process.

Different from the prior arts, the heterostructured photoelectrocatalyst according to of the invention uses plasmons to excite electrons to enhance photocatalytic effect, increases reaction surface area and light capture effect, and reduces electron-hole recombination ratio to increase electron utilization efficiency. Thereby, the heterostructured photoelectrocatalyst according to the invention has high catalytic efficiency.

The advantage and spirit of the invention may be understood by the following recitations together with the appended drawings.

### BRIEF DESCRIPTION OF THE APPENDED DRAWINGS

FIG. 1 is a schematic diagram of the appearance of the heterostructured photoelectrocatalyst according to the preferred embodiment of the invention.

FIG. 2 is an appearance photograph of an example of the heterostructured photoelectrocatalyst according to the preferred embodiment of the invention.

FIG. 3 is a cross-sectional view of the heterostructured photoelectrocatalyst according to the invention in FIG. 1 along the line A-A.

FIGS. 4 through 6 illustratively show a method of fabricating the heterostructured photoelectrocatalyst as shown in FIGS. 1 and 3 with cross-sectional schematic drawings.

FIG. 7 is a scanning electron microscope (SEM) photograph of a top view of silicon nanowires formed by etching for 10 minutes according to an example of the heterostructured photoelectrocatalyst of the invention.

FIG. 8 is an SEM photograph of a cross-section of silicon nanowires formed by etching for 10 minutes according to an example of the heterostructured photoelectrocatalyst of the invention.

FIG. 9 is an SEM photograph of a top view of silicon nanowires formed by etching for 20 minutes according to an example of the heterostructured photoelectrocatalyst of the invention.

FIG. 10 is an SEM photograph of a cross-section of silicon nanowires formed by etching for 20 minutes according to an example of the heterostructured photoelectrocatalyst of the invention.

FIG. 11 shows a diagram of absorbance results measured on specimens deposited with a plurality of gold nanoparticles on a plurality of silicon nanowires according to an example of the invention.

FIG. 12 shows an absorption spectrum measured on a specimen deposited with a plurality of gold nanoparticles on a plurality of silicon nanowires according to an example of the invention.

FIG. 13 is a transmission electron microscope (TEM) photograph of an example of the heterostructured photoelectrocatalyst according to the invention.

FIG. 14 shows a polarization curve diagram of hydrogen evolution reaction of various specimens obtained in various examples of the invention.

FIG. 15 shows a diagram of current density-time measured by various specimens obtained in several examples of the invention with illumination and without illumination.

FIG. 16 is a diagram showing the measurement results of the photocatalytic hydrogen evolution reaction of various specimens obtained in various examples of the invention.

### DETAILED DESCRIPTION OF THE INVENTION

Some preferred embodiments and practical applications of this present invention would be explained in the following paragraph, describing the characteristics, spirit, and advantages of the invention.

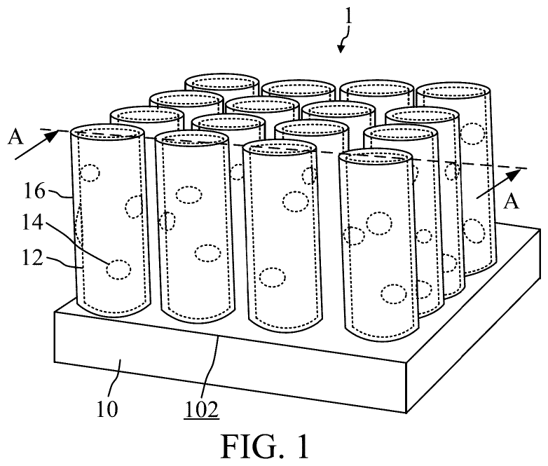

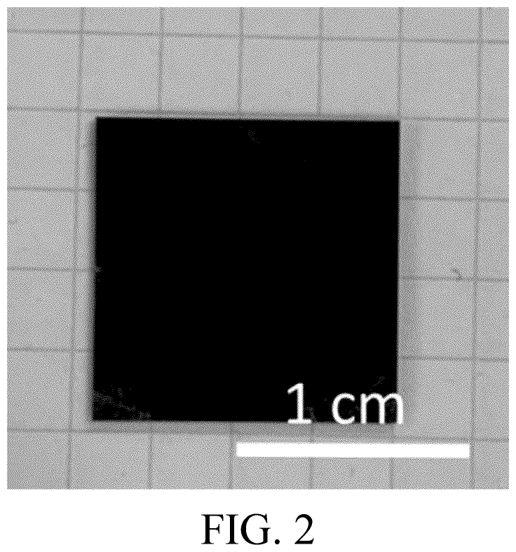

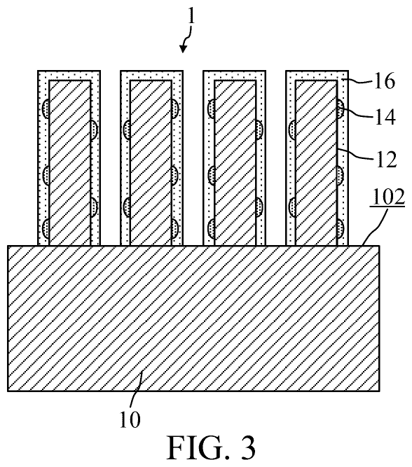

Referring to FIG. 1, FIG. 2 and FIG. 3, those figures schematically illustrate a heterostructured photoelectrocatalyst 1 according to the preferred embodiment of the invention. FIG. 1 schematically shows a heterostructured photoelectrocatalyst 1 according to a preferred embodiment of the invention with an exterior view. FIG. 2 is an appearance photograph of an example of the heterostructured photoelectrocatalyst 1 according to the preferred embodiment of the invention. FIG. 3 is a cross-sectional view of the heterostructured photoelectrocatalyst 1 according to the invention in FIG. 1 along the line A-A. The heterostructured photoelectrocatalyst 1 according to the invention has high catalytic efficiency, and has wide applications in addition to hydrogen evolution reaction, for example, for photocatalytic degradation, air purification (e.g., decomposition of formaldehyde), reduction of CO₂, etc.

As shown in FIG. 1 and FIG. 3, the heterostructured photoelectrocatalyst 1 according to a preferred embodiment of the invention includes a substrate 10, a plurality of nanowires 12, a plurality of metal nanoparticles 14 and a transition metal compound film 16.

The substrate 10 is formed of a semiconductor material. The substrate 10 has an upper surface 102. The semiconductor material has a first conductive type.

The plurality of nanowires 12 are formed of the semiconductor material, and are formed on the upper surface 102 of the substrate 10. The plurality of nanowires 12 are used to reduce the reflection of an incident light, such that the incident light is repeatedly reflected back and forth between the plurality of nanowires 12 and penetrates the transition metal compound thin film 16 multiple times to increase the use efficiency of the incident light.

Referring to FIG. 2, FIG. 2 is an appearance photograph of an example of the heterostructured photoelectrocatalyst 1 according to the preferred embodiment of the invention. Because the plurality of nanowires 12 of the heterostructured photoelectrocatalyst 1 minimize the reflection of incident light, the top surface of an example of the heterostructured photoelectrocatalyst 1 shown in FIG. 2 appears dark.

In one embodiment, a height of each nanowire 12 ranges from 0.5μ m to 15μ m.

In one embodiment, a diameter of each nanowire 12 ranges from 10 nm to 100 nm.

The plurality of metal nanoparticles 14 are formed on the plurality of nanowires 12. Each nanowire 12 thereon exists a few of the plurality of metal nanoparticles 14.

The plurality of metal nanoparticles 14 will generate surface plasmon resonance effect. The heterostructured photoelectrocatalyst 1 according to the invention uses surface plasmon resonance to improve the efficiency of photocatalytic hydrolysis and other reactions, and the mechanisms can be classified into two different types. The first type of mechanism is hot electron injection. When the surface plasmon resonance is excited, the electrons in the metal nanoparticles are promoted to higher energy states and are called hot electrons. Hot electrons can cross the energy barrier between metal nanoparticles and semiconductors and directly inject into the conduction band of semiconductor materials to improve photocatalytic efficiency. After the metal nanoparticles lose electrons, they will reach a charge balance with the anions of the electrolyte. The second type of mechanism is plasma-induced field effect. The probability of generating electron-hole pairs in semiconductor materials is strongly affected by the electric field of the environment, and the generation rate is approximately proportional to the strength of the adjacent electric field. The electric field strength of metal nanoparticles to produce surface plasmon resonance is non-uniformly distributed in space. This electric field has the strongest strength at the interface between the semiconductor and the metal, resulting in the fastest generation rate of electrons and holes at the interface, which can effectively avoid the recombination of electron-hole pairs and improve the efficiency of reactions such as hydrogen evolution.

In one embodiment, the plurality of metal nanoparticles 14 can be formed of silver (Ag), gold (Au), aluminum (Al), copper (Cu), tin (Sn), titanium (Ti), barium (Ba), platinum (Pt), cobalt (Co) or a mixture therebetween.

In one embodiment, a particle size of each metal nanoparticle 14 ranges from 5 nm to 50 nm.

The transition metal compound film 16 is formed to overlap the plurality of nanowires 12 and the plurality of metal nanoparticles 14. The transition metal compound film 16 can be formed of a transition metal sulfide, a transition metal telluride or a transition metal selenide. The transition metal compound film 16 has a second conductive type different from the first conductive type.

The heterostructured photoelectrocatalyst 1 according to the invention uses the light capture effect between the plurality of nanowires 12 to confine the incident light in the plurality of nanowires 12, such that the incident light repeatedly interacts with the transition metal compound thin film 16 and the plurality of metal nanoparticles to make the plasmons excite electrons to catalyze reactions such as hydrogen evolution. The absorption resonance of the plurality of metal nanoparticles 14 can utilize the energy range with the highest intensity in the sunlight spectrum, and the efficient use of sunlight can lead to better efficiency.

The active reaction sites of the granular catalysts used in the prior art are limited, and the electrical conductivity of the granular catalysts used in the prior art is low, such that the catalytic effect of the granular catalysts used in the prior art is very poor. Different from the prior art, the heterostructured photoelectrocatalyst 1 according to the invention uses the two-dimensional material of the transition metal compound film 16 as the basis of the catalyst. There are two strategies to increase the catalytic activity of two-dimensional materials in electrocatalytic reactions. The first strategy is to increase the number of active reaction sites, and the second strategy is to increase the electron transfer between the electrode and the catalyst to make the reaction easier.

Therefore, the heterostructured photoelectrocatalyst 1 forms the transition metal compound thin film 16 to overlay a plurality of nanowires 12 and a plurality of metal nanoparticles 14 to obtain the most active sites, which greatly improves the reaction efficiency such as hydrogen evolution per unit area. The heterostructured photoelectrocatalyst 1 according to of the invention use an ultra-thin transition metal compound film 16 or even an ultra-thin transition metal compound film 16 of a single compound layer can greatly increase the catalytic efficiency.

In one embodiment, the first conductive type is a p-type, and the second conductive is an n-type. The transition metal compound film 16 can be formed of MoS₂, ZnS, CdS, PdS, MoTe₂, WS₂, GeS, GeSe, HfS₃, TiS₃, or Bi₂Te₃.

In another embodiment, the first conductive type is an n-type, and the second conductive is a p-type. The transition metal compound film 16 can be formed of CuS, SnS, Ag₂S or WSe₂.

Some transition metal compounds in the transition metal compound film 16 have a layered structure, for example, a MoS₂ film. In these transition metal compound thin films 16, only the van der Waals force acts between the layers. Therefore, the heterostructured photoelectrocatalyst 1 according to the present invention can greatly increase the surface area and allow electrons to easily transfer through the ultra-thin transition metal compound film 16 such as MoS₂. Moreover, the transition metal compound thin film 16 exhibits a direct energy gap feature in an ultra-thin state, which increases the ability to separate electron-hole pairs, and does not need to consider the crystallization properties and electron transfer efficiency in titanium dioxide.

The transition metal compound thin film 16 of the heterostructured photoelectrocatalyst 1 according to the invention does not contain oxygen, which makes the transition metal compound thin film 16 relatively stable, and the natural oxide layer on the surface can be peeled off when hydrogen bubbles are generated during the hydrogen evolution process, such that the lifetime of the transition metal compound thin film 16 increases. The heterostructured photoelectrocatalyst 1 according to the invention forms the transition metal compound thin film 16 to overlap the plurality of nanowires 12, so the electron transfer efficiency can be further improved. Moreover, the heterostructured photoelectrocatalyst 1 according to the invention is also in a very stable state in aqueous solution, without considering the pH value or electrolyte concentration of the aqueous solution.

In one embodiment, the substrate 10 can be formed of a semiconductor material such as silicon, germanium, diamond, silicon germanium, silicon carbide, gallium arsenide, indium arsenide, indium phosphide, silicon germanium carbide, gallium arsenide phosphide, gallium indium phosphide, and the like. The substrate 10 can be formed from recycled wafers formed of the semiconductor materials mentioned above.

Referring to FIG. 4 through FIG. 6 and FIG. 3, those figures illustratively show a method, according to the preferred embodiment of the invention, of fabricating the heterostructured photoelectrocatalyst 1 as shown in FIGS. 1 and 3 with cross-sectional schematic drawings.

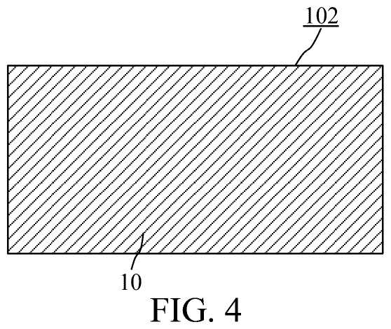

As shown in FIG. 4, firstly, the method according to the preferred embodiment of the invention is to prepare a substrate 10. The substrate 10 is formed of a semiconductor material, and has a first conductive type. In one embodiment, the substrate 10 can be formed of a semiconductor material such as silicon, germanium, diamond, silicon germanium, silicon carbide, gallium arsenide, indium arsenide, indium phosphide, silicon germanium carbide, gallium arsenide phosphide, gallium indium phosphide, and the like.

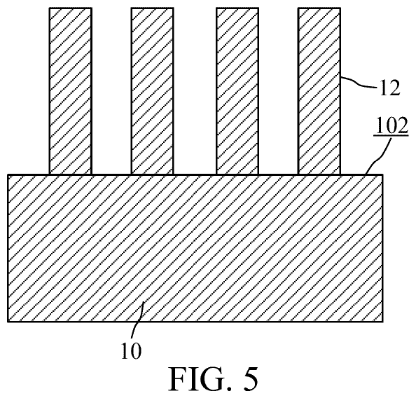

As shown in FIG. 5, then, the method according to the preferred embodiment of the invention is to partially etch the upper surface 102 of the substrate 10 downwards to form a plurality of nanowires 12.

In one embodiment, the plurality of nanowires 12 can be formed by a metal-assisted chemical etching process or a reactive ion etching process.

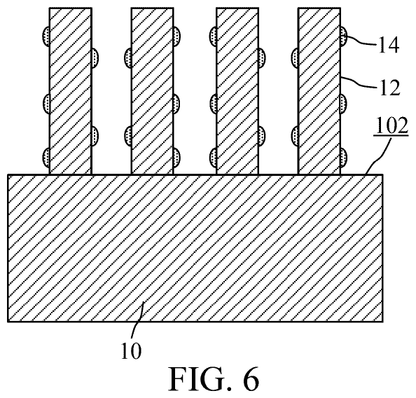

As shown in FIG. 6, next, the method according to the preferred embodiment of the invention is to deposit a plurality of metal nanoparticles 14 on the plurality of nanowires 12. Each nanowire 12 thereon exists a few of the plurality of metal nanoparticles 14.

In one embodiment, the plurality of metal nanoparticles 14 can be formed by dropping a solution containing the metal nanoparticles 14 and then drying, or by an oblique angle deposition process to deposit and attach the metal nanoparticles 14 on the plurality of nanowires 12.

Finally, the method according to the preferred embodiment of the invention is to form a transition metal compound film 16 to overlap the plurality of nanowires 12 and the plurality of metal nanoparticles 14 to finish the heterostructured photoelectrocatalyst 1 as shown in FIG. 3. The transition metal compound film 16 can be formed of a transition metal sulfide, a transition metal telluride or a transition metal selenide. The transition metal compound film 16 has a second conductive type different from the first conductive type.

In one embodiment, the first conductive type is a p-type, and the second conductive is an n-type. The transition metal compound film 16 can be formed of MoS₂, ZnS, CdS, PdS, MoTe₂, WS₂, GeS, GeSe, HfS₃, TiS₃, or Bi₂Te₃.

In another embodiment, the first conductive type is an n-type, and the second conductive is a p-type. The transition metal compound film 16 can be formed of CuS, SnS, Ag₂S or WSe₂.

In one embodiment, the transition metal compound thin film 16 can be formed by a pyrolysis process, a sputtering process, a vacuum evaporation process, a chemical bath deposition process, an atomic layer deposition process, a chemical vapor deposition process, etc.

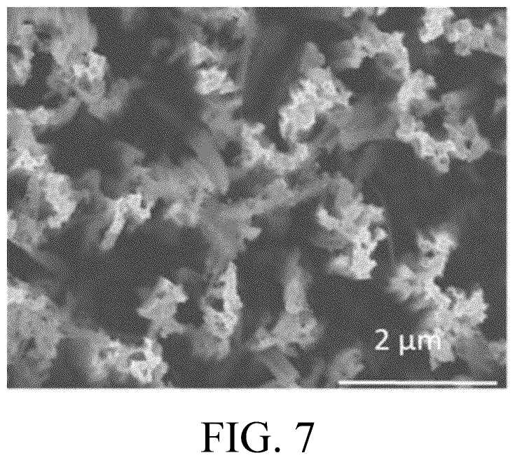

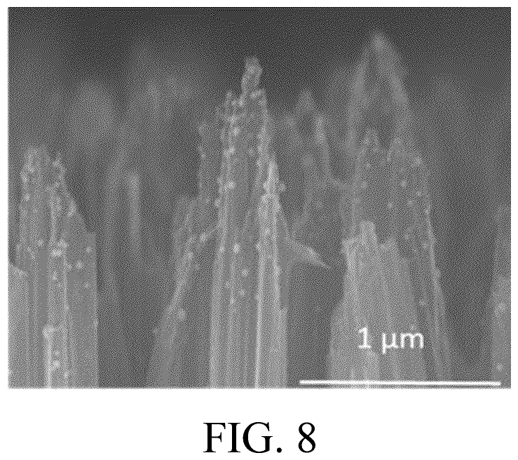

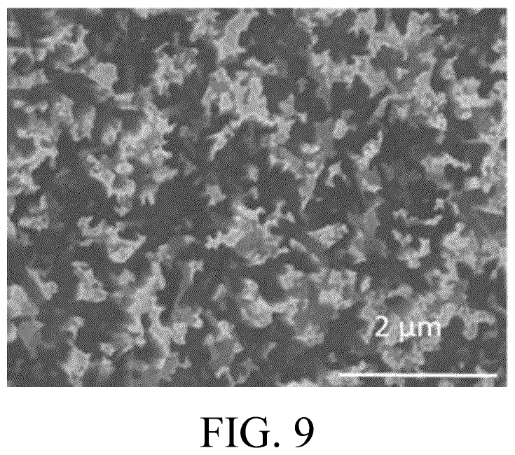

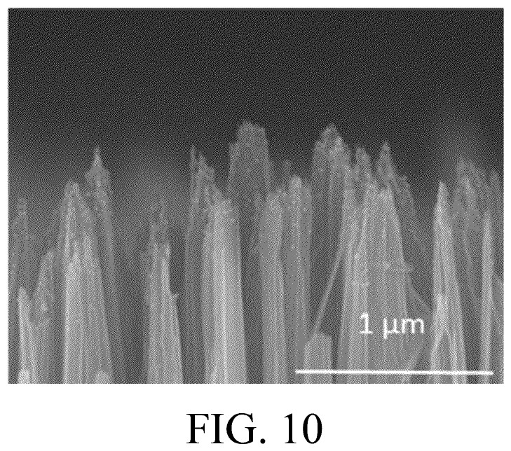

In an example, according to the method of the invention, the substrate 10 is etched into a plurality of nanowires 12 by a metal-assisted chemical etching process. According to the method of the invention, the substrate 10 formed of a silicon is immersed in a solution containing AgNO₃and HF (the concentration of AgNO₃ is 0.44 M and the concentration of HF is 4.6 M) to maintain the immersing time (approx. 10 seconds), and then a plurality of silver nanoparticles are formed on the upper surface 102 of the substrate 10. Next, the substrate 10 is taken out from the solution containing AgNO₃ and HF, and then the substrate 10 is immersed in a solution containing HF and H₂O₂O₂ (the concentration of H₂O₂O₂ is 0.44 M and the concentration of HF is 4.6 M) and maintained for a period of etching time, so as to carry out the metal-assisted chemical etching process, and the original upper surface 102 of the substrate 10 is partially etched downwards to form a plurality of nanowires 12. The etching time of the last step will affect the height of the plurality of nanowires 12. Please refer to FIG. 7, FIG. 8, FIG. 9 and FIG. 10, these figures are SEM photographs of different viewing angles of the plurality of nanowires 12 obtained by maintaining different maintenance etching times in the above example, and subsequently forming a heterogeneous structure of a plurality of gold nanoparticles and a MoS2 film. FIG. 7 is an SEM photograph of a top view of the plurality of nanowires 12 obtained by maintaining the etching time of 10 minutes in the above example. FIG. 8 is an SEM photograph of a cross-sections of the plurality of nanowires 12 obtained by maintaining the etching time for 10 minutes in the above example. FIG. 9 is an SEM photograph of a top view of the plurality of nanowires 12 obtained by maintaining the etching time of 20 minutes in the above example. FIG. 10 is an SEM photograph of a cross-section of the plurality of nanowires 12 obtained by maintaining the etching time of 20 minutes in the above example. The SEM photographs of FIG. 7 and FIG. 8 prove that the average height of the plurality of nanowires 12 obtained by maintaining the etching time of 10 minutes in the above example is about 2μ, and the average diameter of the plurality of nanowires 12 is about 50 nm. The SEM photographs of FIG. 9 and FIG. 10 confirm that the average height of the plurality of nanowires 12 obtained by maintaining the etching time of 20 minutes in the above example is about 6 μm, the average diameter of the plurality of nanowires 12 is about 50 nm, and a large number of gold nanoparticles are scattered on silicon nanowires. The molybdenum disulfide thin film is difficult to observe under the scanning electron microscope.

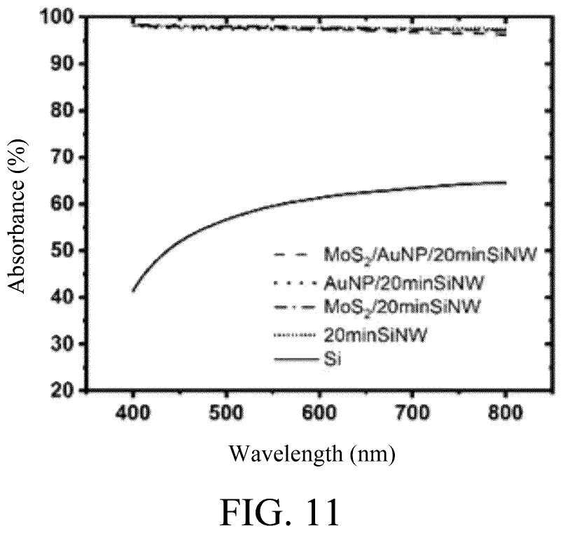

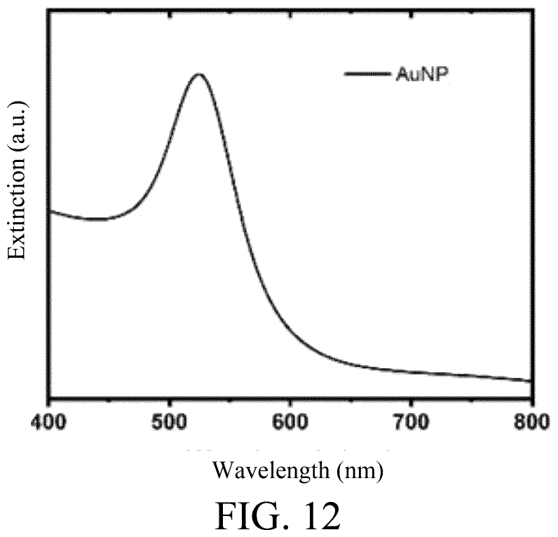

In another example, according to the method of the invention, after the original upper surface 102 of the substrate 10 is partially etched downwards to form a plurality of nanowires 12 (etching time is 20 minutes), a commercial gold nanoparticle-containing solution is used. The solution is directly dropped on the substrate on which the silicon nanowires have been formed and baked to form and deposit a plurality of gold nanoparticles on the plurality of silicon nanowires. The average particle size of the gold nanoparticles formed in the above example is about 40 nm. Please refer to FIG. 11 and FIG. 12. FIG. 11 is a diagram of the absorbance results measured on specimens deposited with a plurality of gold nanoparticles on a plurality of silicon nanowires in the above example. FIG. 12 is the absorption spectrum measured on a specimen deposited with a plurality of gold nanoparticles on a plurality of silicon nanowires in the above example. The results shown in FIG. 11 confirm that the absorbance of the specimen labeled MoS₂/AuNP/20 minSiNW of the above example exceeds 95%. The specimen is labeled 20 minSiNW with etching time of 20 minutes to obtain the plurality of silicon nanowires. The specimen is labeled MoS₂/20 minSiNW with etching time of 20 minutes to obtain the plurality of silicon nanowires and with a MoS₂ film coating. The specimen is labeled AuNP/20 minSiNW with etching time of 20 minutes to obtain the plurality of silicon nanowires and with a plurality of gold nanoparticles deposited thereon. The absorbance of the specimen labeled 20 minSiNW, the specimen labeled MoS₂/20 minSiNW and the specimen labeled AuNP/20 minSiNW are also shown in FIG. 11, and all exceed 95%. The absorbance of the specimen of the silicon substrate (labeled Si) is also shown in FIG. 11, and is much lower than 70%. The results shown in FIG. 12 confirm that the absorption resonance wavelength of the gold nanoparticles formed in the above example is at 520 nm, which is consistent with the spectrum of sunlight.

In another example, according to the method of the invention, after the original upper surface 102 of the substrate 10 is partially etched downwards to form a plurality of nanowires 12

In another example, according to the method of the invention, a silicon substrate is used. And after several silicon nanowires 12 are formed by a metal-assisted chemical etching process (etching time of 20 minutes), the solution containing gold nanoparticles is directly dropped on the silicon substrate on which the silicon nanowires 12 have been formed and baked to form and deposit a plurality of gold nanoparticles on the plurality of silicon nanowires 12. And then, a MoS₂ film is formed by a pyrolysis process to overlap the plurality of gold nanoparticles and the plurality of silicon nanowires. This example prepares a solution of 3.5 wt. % ammonium tetrathiomolybdate ((NH₄)₂ MoS₄) dissolved in dimethylformamide (DMF). Next, in this example, the solution is spin-coated on the silicon nanowires/gold nanoparticles formed on the substrate at a speed of 4000 rpm. And then, the substrate is put into a high-temperature furnace tube, the temperature of the furnace is raised to 450° C. for 45 minutes, and the temperature at 450° C. is maintained for 30 minutes. During the process, a mixed gas of 5 vol. % hydrogen and 95 vol. % argon is introduced at a flow rate of 100 sccm, and baking is performed at 1.8 torr for 10 minutes. Please refer to

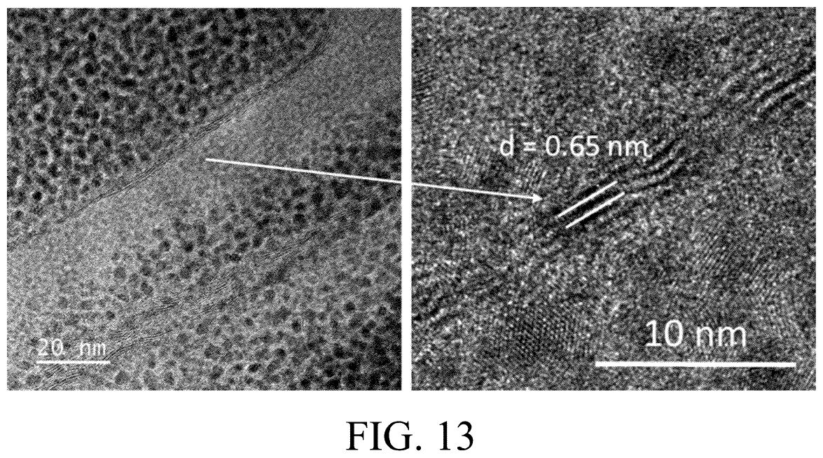

FIG. 13, FIG. 13 is a TEM photograph of the specimen labeled MoS₂/AuNP/20 minSiNW prepared in the above example. The light gray part in the TEM photograph of FIG. 13 is the silicon nanowire structure, the outer layered structure is molybdenum disulfide, and the number of layers of the molybdenum disulfide is about three compound layers. Although the molybdenum disulfide of a single compound layer has excellent catalytic efficiency, the hydrogen bubbles produced by the molybdenum disulfide of several compound layers in the process of hydrogen evolution reaction can strip off the pollutants on the surface, such that the heterostructured photoelectrocatalyst according to the invention has good lifetime and high efficiency.

The invention uses a three-electrode system to measure the photoelectric catalytic hydrogen evolution reaction at room temperature for various specimens obtained in the above examples. The three-electrode system uses Ag/AgCl as the reference electrode, graphite as the auxiliary electrode, and a solar simulator as the light source for irradiation. The graphite is used as the auxiliary electrode to avoid the influence of possible dissolution of the electrodes.

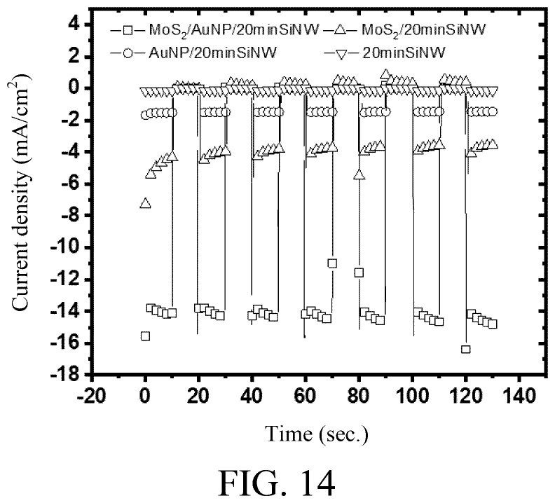

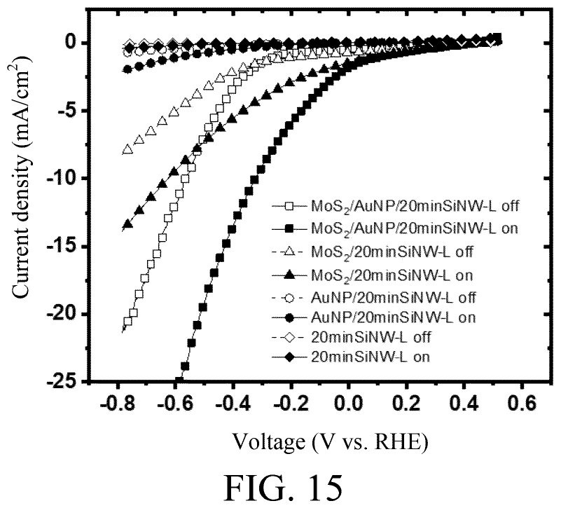

Referring to FIG. 14 and FIG. 15, FIG. 14 is the polarization curves of various specimens obtained in the above examples in 0.5 M sulfuric acid at a scan rate of 5 mV/s for hydrogen evolution reaction. FIG. 15 is the diagram of current density-time measured by various specimens with illumination and without illumination. In

FIG. 14 and FIG. 15, the mark labeled MoS₂represents the MoS₂ thin film, the mark labeled AuNP represents the gold nanoparticles, the mark labeled 20 minSiNW represents the silicon nanowires formed by the etching time of 20 minutes, and the mark labeled 10 minSiNW represents the silicon nanowires formed by the etching time of 10 minutes, “L off” means no illumination, “L on” means illumination. The results shown in FIG. 14 and FIG. 15 confirm that in the part of the photocurrent response, it can be seen that the effect with illumination has a higher current density than that without illumination. Moreover, the current density of the heterostructured specimen labeled MoS₂/AuNP/SiNW is higher than those of the specimen labeled MoS₂/SiNW, the specimen labeled AuNP/SiNW, and the specimen only with silicon nanowires, and the increase of the current density of the heterostructured specimen labeled MoS₂/AuNP/SiNW can reach 113 times. It is sufficient to prove that the heterostructured photoelectrocatalyst according to the invention has excellent photoelectrocatalytic properties.

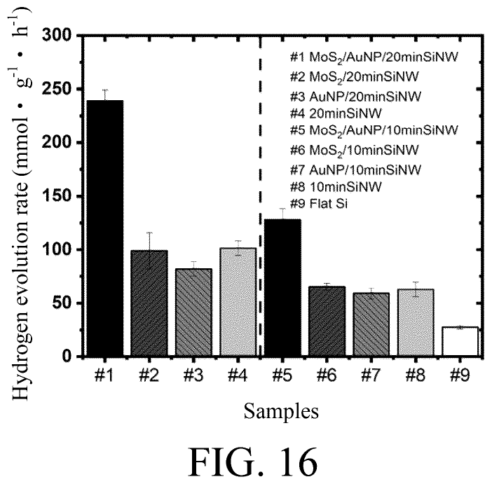

Regarding the measurement of the photocatalytic hydrogen evolution reaction of various specimens obtained in the above examples, the invention uses a gas chromatography to analyze the hydrogen production, and also uses a solar simulator as a light source for irradiation. The above-mentioned hydrogen evolution reaction uses 10 vol. % methanol aqueous solution to avoid chemical reaction to generate between the aqueous solution and the specimen. Please refer to FIG. 16 for the measurement results of the above hydrogen evolution reaction. In FIG. 16, the label “Flat Si” represents a silicon substrate.

The results shown in FIG. 16 confirm that the overall trend of the different specimens is the same as the above photoelectrochemical measurement results, and the results of the heterostructured specimens labeled MoS₂/AuNP/SiNW are better than those of the specimens labeled MoS₂/SiNW, the specimens labeled

AuNP/SiNW and the specimens only with silicon nanowires. Also, the results of the specimens with silicon nanowires formed by maintaining etching time for 20 minutes are better than those of the specimens with silicon nanowires formed by maintaining etching time of 10 minutes. It can be seen that increasing the specific surface area can improve the photocatalytic efficiency, which is the same as expected. The hydrogen evolution rate of the heterostructured specimen labeled MoS₂/AuNP/20 minSiNW is as high as 246 mmol·g⁻¹·h⁻¹, which is a very high hydrogen evolution rate.

In summary, the composite molybdenum disulfide-gold nanoparticles-silicon nanowires formed maintaining etching time for 20 minutes can achieve a 113-fold increase in photocurrent response, and obtain a photocatalytic hydrogen evolution effect of 246 mmol·g⁻¹·h⁻¹. The combination of these three materials can significantly improve the hydrogen evolution effect, and the hydrogen evolution effect can still be maintained under multiple cycles.

With the detailed description of the above preferred embodiments, it is believed that the heterostructured photoelectrocatalyst according to of the invention uses plasmons to excite electrons to enhance photocatalytic effect, increases reaction surface area and light capture effect, and reduces electron-hole recombination ratio to increase electron utilization efficiency. Thereby, the heterostructured photoelectrocatalyst according to the invention has high catalytic efficiency.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A heterostructured photoelectrocatalyst, comprising:
a substrate, formed of a semiconductor material, the substrate having an upper surface, the semiconductor material having a first conductive type;
a plurality of nanowires, formed of the semiconductor material and formed on the upper surface of the substrate;
a plurality of metal nanoparticles, being formed on the plurality of nanowires, each nanowire thereon existing a few of the plurality of metal nanoparticles; and
a transition metal compound film, formed to overlap the plurality of nanowires and the plurality of metal nanoparticles, the transition metal compound film being formed of one selected from the group consisting of a transition metal sulfide, a transition metal telluride and a transition metal selenide, the transition metal compound film has a second conductive type different from the first conductive type.

2. The heterostructured photoelectrocatalyst of claim 1, wherein the plurality of metal nanoparticles are formed of one selected from the group consisting of silver (Ag), gold (Au), aluminum (Al), copper (Cu), tin (Sn), titanium (Ti), barium (Ba), platinum (Pt), cobalt (Co), and a mixture therebetween.

3. The heterostructured photoelectrocatalyst of claim 2, wherein the first conductive type is a p-type, the second conductive is an n-type, the transition metal compound film is formed of one selected from the group consisting of MoS₂, ZnS, CdS, PdS, MoTe₂, WS₂, GeS, GeSe, HfS₃, TiS₃, and Bi₂Te₃.

4. The heterostructured photoelectrocatalyst of claim 2, wherein the first conductive type is an n-type, the second conductive is a p-type, the transition metal compound film is formed of one selected from the group consisting of CuS, SnS, Ag₂S and WSe₂.

5. The heterostructured photoelectrocatalyst of claim 2, wherein a height of each nanowire ranges from 0.5μ m to 15μm , a diameter of each nanowire ranges from 10 nm to 100 nm, a particle size of each metal nanoparticle ranges from 5 nm to 50 nm.

6. A method of fabricating a heterostructured photoelectrocatalyst, comprising the steps of:
preparing a substrate, wherein the substrate is formed of a semiconductor material and has a first conductive type;
partially etching the upper surface of the substrate downwards to form a plurality of nanowires;
depositing a plurality of metal nanoparticles on the plurality of nanowires, wherein each nanowire thereon exists a few of the plurality of metal nanoparticles; and
forming a transition metal compound film to overlap the plurality of nanowires and the plurality of metal nanoparticles, wherein the transition metal compound film is formed of one selected from the group consisting of a transition metal sulfide, a transition metal telluride and a transition metal selenide, the transition metal compound film has a second conductive type different from the first conductive type.

7. The method of claim 6, wherein the plurality of metal nanoparticles are formed of one selected from the group consisting of silver (Ag), gold (Au), aluminum (Al), copper (Cu), tin (Sn), titanium (Ti), barium (Ba), platinum (Pt), cobalt (Co), and a mixture therebetween.

8. The method of claim 7, wherein the first conductive type is a p-type, the second conductive is an n-type, the transition metal compound film is formed of one selected from the group consisting of MoS₂, ZnS, CdS, PdS, MoTe₂, WS₂, GeS, GeSe, HfS₃, TiS₃, and Bi₂Te₃.

9. The method of claim 7, wherein the first conductive type is an n-type, the second conductive is a p-type, the transition metal compound film is formed of one selected from the group consisting of CuS, SnS, Ag₂S and WSe₂.

10. The method of claim 7, wherein a height of each nanowire ranges from 0.5μ m to 15μ, a diameter of each nanowire ranges from 10 nm to 100 nm, a particle size of each metal nanoparticle ranges from 5 nm to 50 nm.
